(19) United States
(12) Patent Application Publication
(10) Pub. No.: US 2025/0239763 A1
(43) Pub. Date: Jul. 24, 2025

(54) WIDE-ANGLE BEAM-SCANNING PHASED ARRAY BASED ON NEAR-FIELD COUPLING AND PORT SELF-DECOUPLING, AND DESIGN METHOD THEREOF

(71) Applicant: South China University of Technology, Guangzhou (CN)

(72) Inventors: Yongmei Pan, Guangzhou (CN); Qixuan Lai, Guangzhou (CN); Zhiming Xiao, Guangzhou (CN)

(21) Appl. No.: 18/749,587

(22) Filed: Jun. 20, 2024

(30) Foreign Application Priority Data
Jan. 23, 2024 (CN) 202410097854.X

(51) Int. Cl. H01Q 3/30; H01Q 21/08

(52) U.S. Cl. CPC H01Q 3/30; H01Q 21/08

(57) ABSTRACT

Disclosed are a wide-angle beam-scanning phased array based on near-field coupling and port self-decoupling and a design method thereof. This design method is different from traditional methods that require introduction of additional beam-broadening and decoupling structures, but aims to obtain wide-beam active element pattern by cleverly utilizing a near-field coupling effect between elements. Meanwhile, port self-decoupling technology is introduced into the phased array to achieve high port isolation and improve beam gain at large scanning angle. Therefore, a phased array with an extremely simple structure and an excellent beam-scanning performance, can be constructed based on typical narrow-beam antenna elements, without requiring additional beam broadening and decoupling structures.

### CROSS-REFERENCE TO RELATED APPLICATION

This disclosure claims priority to Chinese patent Application No. 202410097854.X, filed on Jan. 23, 2024, the content of which is incorporated herein by reference in its entirety.

### TECHNICAL FIELD

This disclosure relates generally to a millimeter-wave wireless communication technology, and particularly relates a wide-angle beam-scanning phased array based on near-field coupling and port self-decoupling, and a design method thereof.

### BACKGROUND

Due to the growing demand for high-speed wireless communication, the millimeter-wave fifth- and sixth-generation (5G/6G) communication technology has received unprecedented attention. However, the inevitable propagation loss of electromagnetic waves in millimeter-wave band seriously restricts the transmission distance of signal. To mitigate this problem, the high-gain millimeter-wave phased arrays capable of beam scanning have been put forward as a mainstream solution. Furthermore, for low cost and good spatial coverage, the phased arrays that have simple structure and wide beam-scanning range are widely desired.

Currently, in order to widen the beam-scanning range of phased arrays, the main approach is to design antenna elements with wide half-power beamwidth (HPBW). Various effective beam-broadening techniques have been put forward, and they can roughly be divided into four categories in terms of implementation schemes. The first category is to load parasitic structures such as metal wall or metal vias which can generate a ∞-shaped pattern and hence enhance the radiation near the low elevation angle. The second category is to superimpose complementary beams provided by different resonant modes, such as the TM₀₁/TM₁₁ mode and zeroth-order resonance mode of microstrip patch antenna (MPA), as well as the fundamental mode and high-order mode of dielectric resonator antenna (DRA). The third category is to directly utilize the wide-beam radiation characteristics of the antenna itself, such as angled dipole antenna, tapered slot antenna, magnetic dipole parallel to the electric wall, and electric dipole parallel to the magnetic wall. The last category is to reconfigure two or multiple beams in different subspaces with the aid of pattern-reconfigurable technique.

Another common approach is to reduce the mutual coupling effect for wide-angle impedance matching (WAIM), which can increase the beam gain at large scanning angles and hence widen the beam-scanning range of phased array. There are also a great many of available decoupling techniques, and according to the decoupling mechanism, they are mainly classified into direct weakening method and indirect compensation method. For the former, the low mutual coupling is achieved by directly weakening the coupled field, by means of metallic via wall, electromagnetic bandgap structure, polarization-conversion isolator, etc. While for the latter, the low mutual coupling is obtained by establishing a new coupling path to counteract the original coupling path, with the aid of symmetrical slots and periodical loops and decoupling networks. Both the two decoupling techniques can offer an improved active impedance matching, but at the cost of increasing antenna complexity due to the introduction of additional decoupling structures.

In summary, the traditional design method of wide-angle beam-scanning phased array aims to broaden element pattern or improve active impedance matching. This usually requires additional beam broadening and decoupling structures, which inevitably increases a structural complexity, losses, and processing costs of phased array. Based on this, a new solution is needed.

### SUMMARY

According to one aspect of this disclosure, a design method for a wide-angle beam-scanning phased array based on near-field coupling and port self-decoupling is provided, wherein the wide-angle beam-scanning phased array includes multiple antenna elements with identical structures, wherein element spacings between adjacent antennas are equal; wherein the design method includes:
obtaining active element patterns (AEPs) of all antenna elements by exciting only the target antenna element, and terminating the remaining antenna elements with matched loads, wherein the target element is the excited element and the remaining elements are the coupled elements;
when the operating mode of the coupled antenna is the same as the resonant mode of the excited element, adjusting the element spacings between antennas to change the coupled field of coupled element including coupling amplitude and phase, so as to broaden the AEP of the excited element, and thus enhancing the scanning angle of the said phased array;
when the operating mode of the coupled antenna is different from the resonant mode of the excited element, adjusting the radiation pattern of the operating mode of the coupled element, so as to broaden the AEP of the excited element, and thus enhancing the scanning angle of the said phased array.

Preferably, in the design method provided by this disclosure, when the operating mode of the coupled antenna is the same as the resonant mode of the excited element, adjusting the element spacings between the antennas to change the coupled field of coupled element, includes:
adjusting the element spacings between the antennas, so as to enable the phases of the coupled fields on both sides of the excited element to be consistent, enable phase differences between said coupled fields and the excited element to be within a range of 120° to 240°, and enable the amplitude of said coupled fields to be not all zero.

Preferably, in the design method provided by this disclosure, the phased array consisted of identical MPA elements is printed on the top surface of a printed circuit board (PCB) and excited by multiple coaxial probes via inset microstrip lines, without requiring additional beam-broadening and decoupling structures.

Preferably, in the design method provided by this disclosure, when the operating mode of the coupled antenna is different from the resonant mode of the excited element, the operating modes of the coupled elements have radiation patterns that are complementary to the resonant mode of the excited element.

Preferably, in the design method provided by this disclosure, when the antenna elements are DRAs, the excited element operates at TE₁₁₃ mode; coupled elements symmetrically distributed on both sides of the excited element feature TE₁₁₂ mode.

Preferably, in the design method provided by this disclosure, each DRA is fed by a microstrip-coupled rectangular slot, wherein the slot is etched on the PCB upper surface and excited by a stepped microstrip line, wherein the microstrip line is printed at the PCB lower surface; the phased array does not require additional beam-broadening and decoupling structures.

This disclosure also provides a wide-angle beam-scanning phased array, which is designed according to the design method for a wide-angle beam-scanning phased array based on near-field coupling discussed above and port self-decoupling.

This disclosure has at least following beneficial effects. This disclosure provides wide-angle beam-scanning phased arrays based on near-field coupling and port self-decoupling and a design method thereof, which use a near-field coupling effect to obtain a wide beamwidth AEP, and meanwhile use self-decoupling technology to provide high port isolation to further improving a beam gain at large scanning angle. Therefore, by using ordinary narrow-beam antenna elements, a simple wide-angle beam-scanning phased array can be achieved without requiring any additional beam-broadening or decoupling structure.

### BRIEF DESCRIPTION OF THE DRAWINGS

In order to more clearly explain the embodiments of this disclosure, the following briefly introduces the drawings which are needed to be used in the description of the embodiments. It is obvious that the drawings in the following description are only some embodiments of this disclosure. For those skilled in the art, other drawings can be obtained from these accompanying drawings without paying any creative works.

FIG. 1 is a schematic diagram for a 1×5 E-plane ideal linear array.

FIGS. 2 (a)-(b) show normalized element patterns G(θ) for different amplitudes and phases, when a=b, φ₁=φ₂; wherein (a) shows different amplitudes a (φ₁=180°); (b) shows different phases φ₁(a=0.6).

FIG. 3 shows normalized element patterns G(θ) for different phases Δφ=φ₁-φ₂(a=0.6, φ₁=180°), when a=b, φ₁≠φ₂.

FIG. 4 shows normalized element patterns G(θ) for different b/a ratios, when a≠b, φ₁=φ₂.

FIG. 5 is a structural diagram of 1×8 millimeter-wave E-plane MPA phased array proposed in Example 1.

FIG. 6 shows simulated reflection coefficients of elements 1-8 and transmission coefficients between adjacent elements 1-8 of the millimeter-wave E-plane MPA phased array proposed in Example 1.

FIGS. 7 (a)-(c) show simulated active reflection coefficients of elements 1-8 of the millimeter-wave E-plane MPA phased array, at different scanning angles, wherein (a) 0°, (b) 27°, and (c) 63°.

FIGS. 8 (a)-(b) show simulated scanning performance of the millimeter-wave E-plane MPA phased array proposed in Example 1 at a frequency of 26 GHZ, wherein (a) co-polarization, and (b) cross-polarization.

FIG. 9 shows E-plane AEP of elements 5 and 8, and E-plane IEP at a frequency of 26 GHz.

FIGS. 10 (a)-(b) show a simulated current distribution on the proposed millimeter-wave E-plane MPA phased array, when only element 5 or element 8 is excited at a frequency of 26 GHz, wherein (a) element 5 is excited, and (b) element 8 is excited.

FIG. 11 is a structural diagram of 1×8 millimeter-wave H-plane DRA phased array proposed in Example 2.

FIG. 12 shows simulated reflection coefficients of elements 1-4 and transmission coefficients between adjacent elements 1-4 of the millimeter-wave H-plane DRA phased array proposed in Example 2.

FIGS. 13 (a)-(c) show simulated active reflection coefficients of elements 1-4 of the millimeter-wave H-plane DRA phased array, at different scanning angles, wherein (a) 0°, (b) 28°, and (c) 61°.

FIGS. 14 (a)-(b) show simulated scanning performance of the millimeter-wave H-plane DRA phased array proposed in Example 2, at a frequency of 26 GHz, wherein (a) co-polarization, and (b) cross-polarization.

FIG. 15 shows H-plane AEP of elements 1 and 5, and H-plane IEP at a frequency of 26 GHz.

FIGS. 16 (a)-(b) show simulated current distributions on the proposed millimeter-wave H-plane DRA phased array, when only element 4 or element 1 is excited at a frequency of 26 GHz, wherein (a) element 4 is excited, and (b) element 1 is excited.

FIG. 17 (a) is an equivalent radiation model of coupled element 3 or 5, and FIG. 17 (b) is H-plane radiation pattern of said equivalent radiation model.

### DETAILED DESCRIPTION OF THE PREFERRED EMBODIMENT

For the convenience of understanding this disclosure, a more comprehensive description of this disclosure is provided below with reference to the relevant drawings. A typical embodiment of this disclosure is shown in the attached drawings. However, this disclosure can be implemented in many different forms, not limited to the embodiments described herein. On the contrary, the purpose of providing these embodiments is to make the disclosed content of this disclosure more thorough and comprehensive.

Unless otherwise defined, all technical and scientific terms used in this disclosure have the same meanings as those commonly understood by those skilled in the art. The terms used in this disclosure are only for the purpose of describing specific embodiments and are not intended to limit this disclosure.

As is well known, the radiation pattern of a phased array is mainly determined by three factors, including isotropic array factor (IAF), isolated element pattern (IEP), and impedance mismatch factor (IMF). For an N-element phased array with equal amplitude and element spacing, the IAF can be expressed as equation (1):

$$AF = {\sum }_{n = 1}^{N} {e}^{j ( n - 1 ) kdsin θ + j ( n - 1 ) Δφ} . \qquad ( 1 )$$

Wherein, k is the wavelength, d is the element spacing, θ is the scanning angle, and Δφ₀ is the phase difference between adjacent elements. It can be inferred from (1) that when the phase difference is set to Δφ₀, AF reaches a maximum value N at θ₀, which means that the main beam of the phased array is scanned to θ₀. In addition, at any scanning angle θ, the maximum value of AF is always equal to the elements number N. Therefore, the IAF will not affects the beam-scanning performance of the phased array.

IEP refers to a radiation pattern of isolated antenna element. In theory, ignoring mutual coupling effect, when the HPBW of IEP is θₑ, the 3-dB beam-scanning range of the corresponding phased array can reach ±θₑ/2. However, in reality, due to existence of antenna coupling, the beam-scanning range is more directly related to the AEP of all elements. Specifically, the wider the HPBW of AEP is, the broader the 3-dB beam-scanning range of the phased array will have. Due to the fact that a wide-HPBW IEP generally leads to wide-HPBW AEP, wide-angle beam-scanning phased arrays can usually be implemented by using wide beam antenna elements.

On the other hand, the inferior IMF may have a negative impact on the AEP and worsen the scanning performance of phased array accordingly. The influence of IMF can be characterized by the near-field coupling and the port coupling. The former can sometimes cause distortion of AEP, which enlarges the gain fluctuation during beam scanning and even causes scan blindness, while the latter will degrade the active reflection coefficients of all elements, especially at large scanning angles, thereby decreasing the beam gain of phased array.

For the above reasons, the traditional design methods for wide-angle beam-scanning phased arrays aim to either widen the IEP (for widebeam AEP) or improve the IMF (for WAIM). Additional beam-broadening and decoupling structures are generally required, which inevitably increase the structural complexity, loss, and processing cost of phased array.

Therefore, regarding the technical problem that the traditional design method of wide-angle beam-scanning phased array needs additional beam broadening and decoupling structures, which inevitably increases the structural complexity, losses, and processing costs of the phased array, this disclosure provides a wide-angle beam-scanning phased array based on near-field coupling and port self-decoupling and a design method thereof, which utilize the near-field coupling effect to obtain wide-beam AEP, and also adopt self-decoupling technology to provide high port isolation and WAIM. Therefore, by using ordinary narrow-beam antenna elements, a simple wide-angle beam-scanning phased array can be achieved without requiring any additional beam broadening and decoupling structures.

This disclosure provides a design method for a wide-angle beam-scanning phased array based on near-field coupling and port self-decoupling, wherein the wide-angle beam-scanning phased array includes multiple antenna elements identical structures, and element spacings between the adjacent antenna are equal. The beam scanning is achieved by modulating the amplitude and phase of each antenna element. The radiation pattern of a phased array can be obtained by superimposing AEPs of all antenna elements.

Wherein the design method includes following steps.

In step 1, obtaining AEPs of all antenna elements by exciting only the target antenna element, and terminating the remaining antenna elements with matched loads, wherein the target element is the excited element and the remaining elements are the coupled elements.

Specifically, wide-beam AEP is obtained through a near-field coupling effect, which is the key to achieving wide-angle beam-scanning. In near-field coupling, there are usually two situations, in which an operating mode of the coupled element is the same as a resonant mode of excited element, or an operating mode of the coupled element is different from a resonant mode of excited element. The following will introduce these two situations separately.

In step 2, when the operating mode of the coupled antenna is the same as the resonant mode of the excited element, adjust the element spacings between antennas to change the coupled field of coupled element including coupling amplitude and phase, so as to broaden the AEP of the excited element based on a near-field coupling effect between the coupled element and the excited element, and thus enhancing the scanning angle of the said phased array.

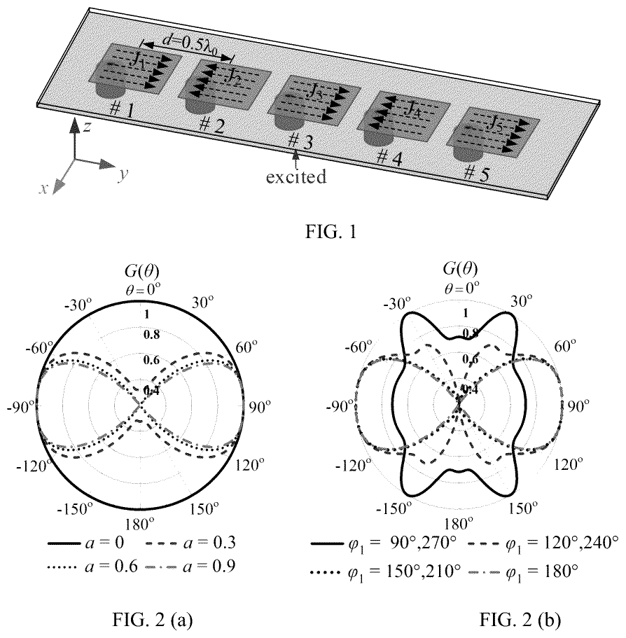

Specifically, for linear arrays, the near-field coupling mainly occurs in an element central region with a radius of approximately λ₀, the near-field coupling beyond this region becomes very weak due to a long coupling path. Therefore, the 1×5 E-plane ideal linear array with an element spacing of 0.5λ, shown in FIG. 1, is used to study the E-plane AEP of the central element in the presence of near-field coupling effect. In this array, only central element 3 is excited, while all other elements are connected with a matched load. Due to the mutual coupling effect, the excited current J₃ on the active element 3 will be coupled to the adjacent passive elements 2 and 4. Generally, the directions of the coupled current J₂ and J₄ are the same but they are opposite to the direction of the excited current J₃, and the amplitudes of J₂ and J₄ are weaker than J₃. On the other hand, the coupled current J₂ and J₄ will serve as new excitation sources which will be coupled to the adjacent passive elements 1 and 5 respectively, forming coupled current J₁ and J₅. Similarly, the directions of the coupled current J₁ and J₅ are the same but they are opposite to those of J₂ and J₄, and the amplitudes of J₁ and J₅ are weaker than those of J₂ and J₄. For ease of analysis, it is assumed that the amplitude and phase of J₃ are 1 and 0° respectively, and they are tabulated in Table 1 together with the information of other coupled current. Additionally, it is assumed that the coupling situation from element 3 to element 2 (element 3 to element 4), including coupling strength and coupling phase, is consistent with that from element 2 to element 1 (element 4 to element 5). Therefore, when the amplitudes & phases of J₂ and J₄ are assumed to be a & φ₁ and b & φ₂ respectively, the amplitudes & phases of J₁ and J₅ will be a² & 2φ₁ and b² & 2φ₂ respectively. Consequently, the E-plane AEP of element 3 can be expressed as (2):

$${F}_{E} ( θ ) = {f}_{e} ( θ ) \times G ( θ ) . \qquad ( 2 )$$

Wherein, fₑ(θ) represents E-plane IEP, G(θ) is a factor related to near-field coupling, given by formula (3):

$$G ( θ ) = {a}^{2} {e}^{- 2 jkdsin θ + 2 j {φ}_{1}} + a {e}^{- jkdsin θ + j {φ}_{1}} + 1 + b {e}^{jkdsin θ + j {φ}_{2}} + {b}^{2} {e}^{2 jkdsin θ + 2 j {φ}_{2}} \qquad ( 3 )$$

For an antenna element, its IEP is determined. Therefore, it can be inferred that the E-plane AEP is only related to G(θ). In the following study, G(θ) is studied for three different coupling scenarios.

TABLE 1
Amplitude and phase of the coupled and excited current

| Current | J₁ | J₂ | J₃ | J₄ | J₅ |
|---|---|---|---|---|---|
| Amplitude | a² (a < 1) | a | 1 | b (b < 1) | b² |
| Phase | 2φ₁ | φ₁ | 0° | φ₂ | 2φ₂ |

The first scenario is a=b, φ₁=φ₂, which means that the coupling strengths on both sides of the active element 3 are equal and the coupling phases are synchronous. In this case, G(θ) can be expressed as (4):

$$G ( θ ) = {a}^{2} {e}^{- 2 jkdsin θ + 2 j {φ}_{1}} + a {e}^{- jkdsin θ + j {φ}_{1}} + 1 + a {e}^{jkdsin θ + j {φ}_{1}} + {a}^{2} {e}^{2 jkdsin θ + 2 j {φ}_{1}} \qquad ( 4 )$$

and accordingly, the normalized patterns of G(θ) for different amplitudes a (assuming φ₁=180°) can be obtained, as shown in FIG. 2 (a). It can be seen that when a=0 (no energy is coupled to the passive elements), G(θ) is isotropic and equal to 1, hence the AEP becomes the IEP. As a increases, the value of G(θ) near the boresight direction (θ=0°) decreases while that near the equatorial direction (θ=90°) remains the maximum, accordingly G(θ) presents a shape of “∞”. When the ∞-shaped G(θ) is multiplied by a broadside IEP fₑ(θ) whose maximum radiation occurs at the boresight direction, a more uniform AEP with wide beamwidth will be obtained. FIG. 2 (b) shows the normalized patterns of G(θ) for different coupling phases φ₁ (assuming a=0.6). As illustrated, when φ₁=90°, 270°, the maximum values of G(θ) are found at ±30°& ±150° and G(θ) presents a shape of “X”. As φ₁ increases from 90° to 180°, the pattern of G(θ) gradually changes into ∞-shaped, and thus can also expand the AEP. Here, it is worth mentioning that the ∞-shaped or quasi ∞-shaped G(θ) can be achieved for a large range of a and φ₁ (say a ∈[0.3, 0.9], φ₁∈[120°, 240°]), which exhibits a high degree of design flexibility in obtaining widebeam AEP via near-field coupling effect.

The second scenario is a=b, φ₁≠φ₂, which means that the coupling strengths on the two sides of element 3 are equal but the coupling phases are asynchronous. Therefore, in this case, G(θ) can be expressed as:

$$G ( θ ) = {a}^{2} {e}^{- 2 jkdsin θ + 2 j {φ}_{1}} + a {e}^{- jkdsin θ + j {φ}_{1}} + 1 + a {e}^{jkdsin θ + j {φ}_{2}} + {a}^{2} {e}^{2 jkdsin θ + 2 j {φ}_{2}} . \qquad ( 5 )$$

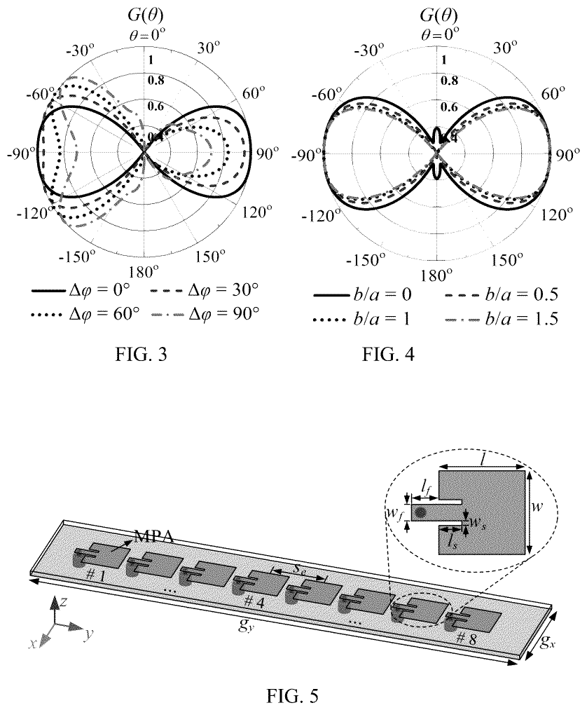

On the basis of (5), FIG. 3 shows the normalized patterns of G(θ) for different phase differences Δφ=φ₁-φ₂ (assuming a=0.6, φ₁=180°). It can be seen that G(θ) is very sensitive to Δφ, and as the phase difference Δφincreases, the symmetric ∞-shaped pattern of G(θ) becomes asymmetric accordingly. To be specific, the left maximum radiation angle deviates from the endfire direction and splits into two, and the right maximum radiation angle remains at the endfire direction but its intensity decreases rapidly. Obviously, according to (2), such asymmetric G(θ) pattern will seriously deteriorate the AEP. Therefore, when using near-field coupling effect to broaden AEP, it should be ensured that the phases of the coupled fields on both sides of the excited element are consistent.

The third scenario is a≠b, φ₁=φ₂, which means that the coupling strengths on both sides of element 3 are unequal but the coupling phases are synchronous. In this case, G(θ) is given by (6):

$$G ( θ ) = {a}^{2} {e}^{- 2 jkdsin θ + 2 j {φ}_{1}} + a {e}^{- jkdsin θ + j {φ}_{1}} + 1 + b {e}^{jkdsin θ + j {φ}_{1}} + {b}^{2} {e}^{2 jkdsin θ + 2 j {φ}_{1}} . \qquad ( 6 )$$

FIG. 4 shows the normalized patterns of G(θ) for different ratios of b/a (assuming a=0.6, φ₁=180°). It can be seen that, when the ratio increases significantly from 0 to 1.5, G(θ) changes slightly and always presents an ∞-shaped pattern. This result indicates that regardless of the near-field coupling strength, as long as the coupling phases from the excited field to the coupled field remain synchronous and keep at around 180°, the beam-broadening effect of near field on the AEP will not be affected. Even when the coupling strength on one side is ideally zero (b/a=0), the ∞-shaped G(θ) can be achieved as shown by the black solid line, which means that the AEPs of edge elements (i.e., elements 1 and 5 in FIG. 1) can also potentially be widened using near-field coupling effect.

It should be mentioned that all the above analyses are applicable to the H-plane phased array. Whether in the E-plane or H-plane, the AEP is obtained from the superposition of the radiations generated by excited and coupled fields, in which the coupled field that is intimately correlated with the near-field coupling effect plays a non-negligible role.

Therefore, in step S2, when the antenna elements are MPAs and the operating mode of the coupled antenna is the same as the resonant mode of the excited element, adjust the element spacings between the antennas, so as to enable the phases of the coupled fields on both sides of the excited element to be consistent, enable phase differences between said coupled fields and the excited element to be within a range of 120° to 240°, and enable the amplitude of said coupled fields to be not all zero.

Step S3, when the operating mode of the coupled antenna is different from the resonant mode of the excited element, adjust the radiation pattern of the operating mode of the coupled element, so as to broaden the AEP of the excited element based on a near-field coupling effect between the coupled element and the excited element, and thus improving the scanning performance of the said phased array.

Specifically, considering the fact that the excitation sources for the excited element and coupled element are different (specifically, the excitation source for the excited element is its feeding network, while that for the coupled element is the resonant near field of the excited element), it is possible that the operating mode in coupled element is different from the resonant mode in excited element. For example, when the antenna elements are DRAs, the excited DRA operates in the TE₁₁₃ mode, but its adjacent coupled DRA presents the field distributions of the TE₂₁₁ or TE₁₁₂ mode. In this case, the near-field coupling effect can also expand the AEP due to the complementary radiation patterns of the excited and coupled modes. Therefore, in step S3, the operating mode of the coupled element is different from the resonant mode of the excited element. The excited element operates at TE₁₁₃ mode; coupled elements symmetrically distributed on both sides of the excited element are coupled TE₁₁₂ mode. Since this coupled mode cannot be excited through coupling slots, port self-decoupling is achieved, which improves active impedance matching of the antenna and increases the beam gain at large scanning angle. In addition, for the H-plane the radiation pattern of the TE₁₁₂ mode of the coupled element, a radiation null appears in the boresight direction and the maximum radiation occurs at ±60° and ±120°. When this radiation pattern is superimposed with the pattern of the excited element, the gains near ±60° and ±120° are reinforced while the gain in the boresight direction remains almost unchanged, thereby giving a more uniform AEP of excited element.

Furthermore, in an embodiment of this disclosure, when the antenna elements are MPAs, the MPA phased array is printed on the top layer of the PCB and fed by multiple coaxial probes via an inset microstrip line. This inset feeding structure can generate new coupling paths to counteract the original coupling of the radiation patch, making the field at the place of the coupled MPA very weak, thereby achieving extremely low mutual coupling levels between adjacent elements and improving the beam gain of the phased array at large scanning angles without requiring additional decoupling structures.

Furthermore, in an embodiment of this disclosure, when the antenna elements are DRAs, each DRA is fed by a microstrip-coupled rectangular slot, which slot is etched on the PCB upper surface and excited by a stepped microstrip line, which line is printed at the PCB lower surface. The excited element operates at TE₁₁₃ mode; coupling elements symmetrically distributed on both sides of the excited element are coupled TE₁₁₂ mode. Since this coupled mode cannot be excited through coupling slots, extremely low coupling levels between adjacent elements can be achieved without requiring additional decoupling structures.

Below are two detailed examples to elaborate on the methods of this disclosure.

### Example 1: 1×8 Millimeter-Wave E-Plane MPA Phased Array

This embodiment designs a 1×8 millimeter-wave E-plane wide-angle beam-scanning MPA phased array to verify the feasibility of the proposed design method.

FIG. 5 illustrates the configuration of the proposed millimeter-wave E-plane MPA phased array, which consists of eight identical MPA elements with element spacing of Se. These MPA elements are printed on the top surface of a rectangular printed circuit board (PCB) which has a thickness of 0.508 mm and a dielectric constant of 2.2. In addition, all MPA elements are excited by a 50Ω coaxial probe via an inset microstrip line. Such kind of inset-fed MPA can counteract the coupling from the radiating patch by the coupling from the feeding structure, making the field at the place of the coupled MPA rather weak and hence achieving a very low mutual-coupling level between the adjacent elements without the need of additional decoupling structure. The proposed MPA phased array is designed to work at 26 GHz millimeter-wave band, and its detailed dimensions are listed in Table 2.

TABLE 2
Dimension of proposed millimeter-
wave E-plane MPA phased array

| Parameter | gₓ | g_{y} | sₑ | l | w |
|---|---|---|---|---|---|
| Value (mm) | 10.0 | 57.8 | 5.4 | 3.77 | 3.77 |

| Parameter | l_{f} | w_{f} | lₛ | wₛ |
|---|---|---|---|---|
| Value (mm) | 1.2 | 0.76 | 1.0 | 0.2 |

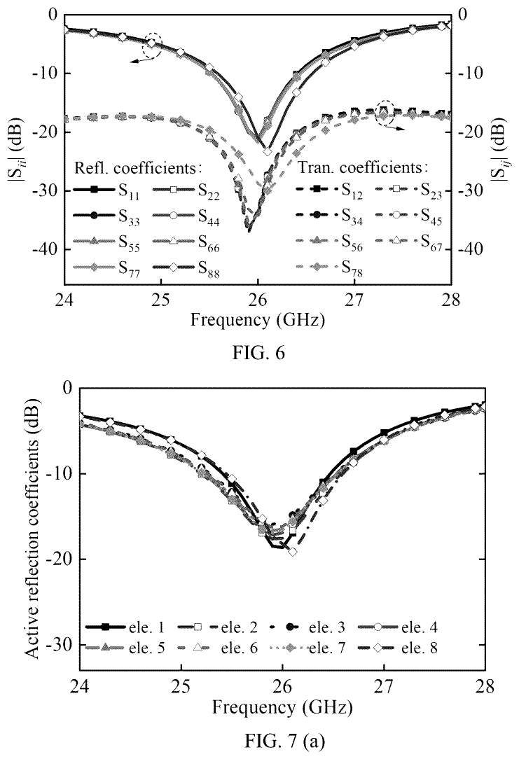

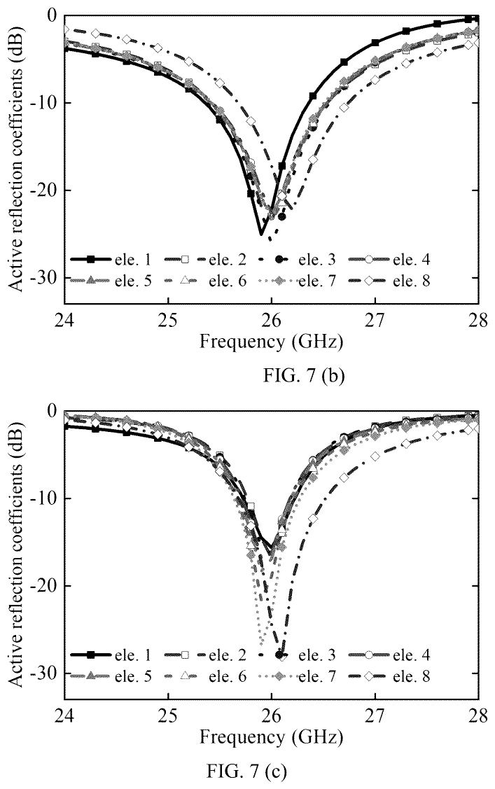

FIG. 6 shows the simulated reflection coefficients of all elements and transmission coefficients between adjacent elements in the proposed E-plane MPA phased array. It can be seen that the reflection coefficients of these eight elements are almost identical, having a good impedance matching level and giving an overlapping −10 dB impedance bandwidth of 3.1% ranging from 25.6 to 26.4 GHz. Also, the transmission coefficients between any two adjacent elements are very close, which are lower than −28.7 dB at 26 GHz, showing high port isolation as expected due to the self-decoupling effect. FIGS. 7 (a)-(c) show the simulated active reflection coefficients of this MPA phased array at different scanning angles 0°, 27° and 63°. As can be observed, at the three sampled angles, all antenna elements achieve good active impedance matching around 26 GHZ, and similar results are observed at other scanning angles, indicating that this MPA phased array has achieved WAIM with the help of port self-decoupling technology.

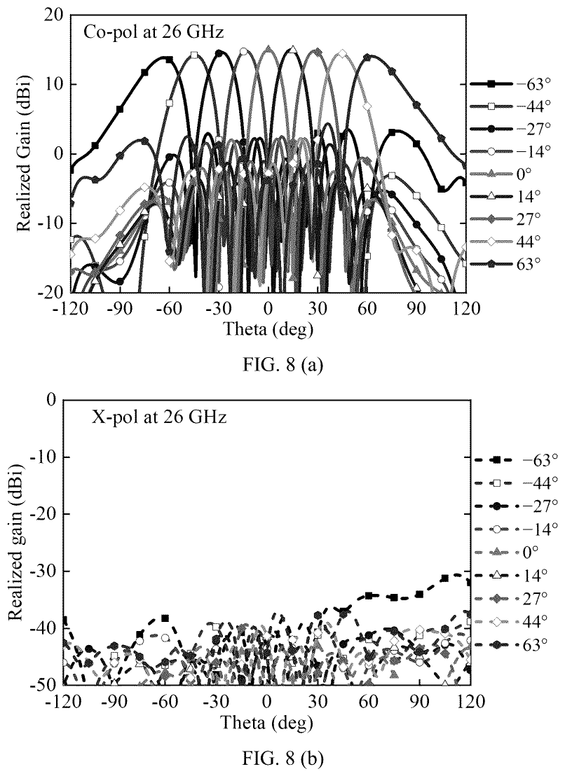

FIGS. 8 (a)-(b) show the simulated scanning performance of the proposed MPA phased array at 26 GHz. As observed, the main beam can scan from −63° to +63° with a low gain variation of 1.2 dB, and the peak SLL is lower than −10.5 dB over the wide scanning range. Thanks to the realization of WAIM, the beam gain at the angle of −63° is as high as 13.8 dBi, and the maximum beam gain at 0° is up to 15.0 dBi. Within the entire scanning range, the co-polarized field is higher than the cross-polarized field by at least 44.5 dB.

In summary, the proposed MPA phased array achieves a wide scanning range of over 126° (±63°, the 3-dB beam-scanning range can reach ±68° when ignoring the degradation of SLL), as well as very outstanding gain and polarization performance. Notably, these good features cannot be attributed to the MPA element only as its E-plane HPBW is limited to 96°.

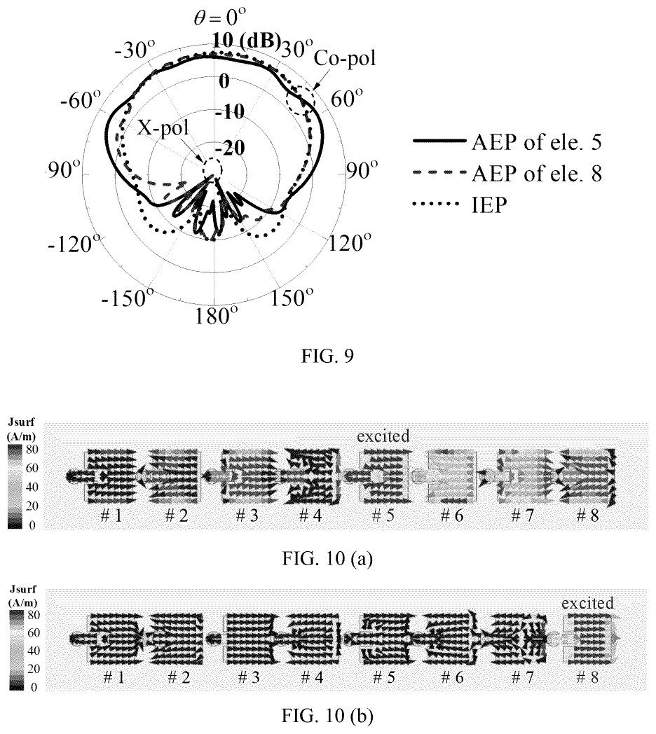

In fact, the realization of wide beam-scanning range attributes to the interelement near-field coupling effect, which offers widebeam AEP. To elaborate the principle, FIG. 9 shows the E-plane AEPs of the central element 5 and the edge element 8, and the E-plane IEP is also included for comparison. It can be seen that, compared to the IEP, the AEP of element 8 is very similar in the upper half space, while the AEP of element 5 has a much wider beamwidth. The specific HPBWs of AEPs for element 5, element 8, and all other elements in the MPA phased array are listed in Table 3. It can be seen that, the HPBWs of all AEPs are wider than that of the IEP, especially those for elements 1-6, which are over 140°. Although the AEP beamwidths of the edge elements 7 and 8 are only 121° and 99° respectively, they have little effect on the scanning performance of the proposed phased array. Additionally, it can be seen from FIGS. 8 (a)-(b) that the cross-polarization levels of AEP and IEP are comparable, and they are all lower than −40 dB.

TABLE 3
HPBW of E-plane IEP and AEP for all elements
in the proposed MPA phased array

| Element | IEP | 1 | 2 | 3 | 4 | 5 | 6 | 7 | 8 |
|---|---|---|---|---|---|---|---|---|---|
| HPBW/° | 96 | 143 | 148 | 151 | 153 | 153 | 148 | 121 | 99 |

Further, to explain the broadening mechanism of AEPs, the near-field coupling effects in element 5 and element 8 are studied. FIGS. 10 (a)-(b) plot the simulated current distributions on the proposed E-plane MPA phased array, when only element 5 (FIG. 10(a)) or element 8 (FIG. 10(b)) is excited. As illustrated, when only element 5 is excited, the intensities of current on the right coupled MPAs are much stronger than those on the left MPAs, which is caused by the inconsistent coupling strengths on both sides of the excited element. As a result, the AEP of element 5 mainly depends on its excited current and the coupled current on the passive elements 6 and 7. In this case, according to the analyses in Section II-B, G(θ) can be expressed as (7):

$$G ( θ ) = 1 + {be}^{{jks}_{e} sin θ + j {φ}_{2}} + {b}^{2} {e}^{2 {jks}_{e} sin θ + 2 j {φ}_{2}} . \qquad ( 7 )$$

G(θ) presents an “∞” shape, thus offering a widebeam AEP. Differently, when only the rightmost element 8 is excited, the coupled current on all passive elements is very weak, so G(θ) is very close to 1 and it does little to widen the AEP, leading to a narrow-beam AEP that is nearly consistent with the IEP. These analyses show the important role of near-field coupling effect in widening the AEP, and also explain why different elements have different AEPs (see FIG. 9).

### Example 2: 1×8 Millimeter-Wave H-Plane DRA Phased Array

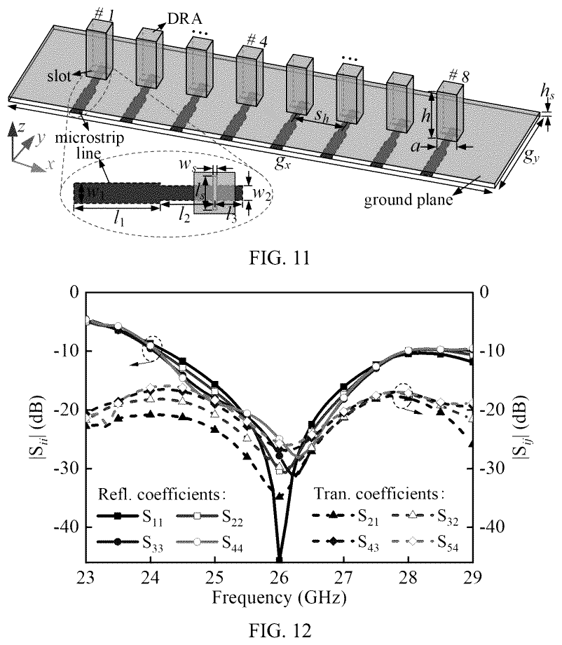

FIG. 11 shows the configuration of the proposed 1×8 millimeter-wave H-plane DRA phased array, which consists of eight square DRA elements with side-length a, height h, and dielectric constant εᵣ₁. Each DRA is fed by a microstrip-coupled rectangular slot with dimension of lₛ×wₛ. The slot is etched on the upper surface of a square PCB with thickness hₛ and dielectric constant εᵣ₂, and it is excited by a 50Ω microstrip line that is printed on the PCB lower surface. Here, for good impedance matching, the stepped microstrip line is applied. Also, the proposed DRA phased array is designed to work at 26 GHz millimeter-wave band, and its detailed dimensions are listed in Table 4. Notably, in this design, the port self-decoupling technology proposed is implemented by properly designing the operating modes (dimensions) in excited and coupled DRA elements. Specifically, the excited DRA operates in the TE₁₁₃ mode while the coupled DRA presents the field pattern of TE₁₁₂ mode whose magnetic field intensity is rather weak at the position of feeding slot, giving an extremely low mutual coupling level.

TABLE 4
Dimension of the proposed millimeter-
wave H-plane DRA phased array

| Parameter | a | h | sₕ | εᵣ₁ | gₓ | g_{y} | hₛ | εᵣ₂ |
|---|---|---|---|---|---|---|---|---|
| Value (mm) | 2.25 | 5.6 | 5.4 | 9.9 | 53.5 | 15.0 | 0.254 | 2.2 |

| Parameter | w₁ | w₂ | l₁ | l₂ | l₃ | lₛ | wₛ |
|---|---|---|---|---|---|---|---|
| Value (mm) | 0.9 | 0.8 | 4.6 | 2.9 | 1.5 | 1.8 | 0.2 |

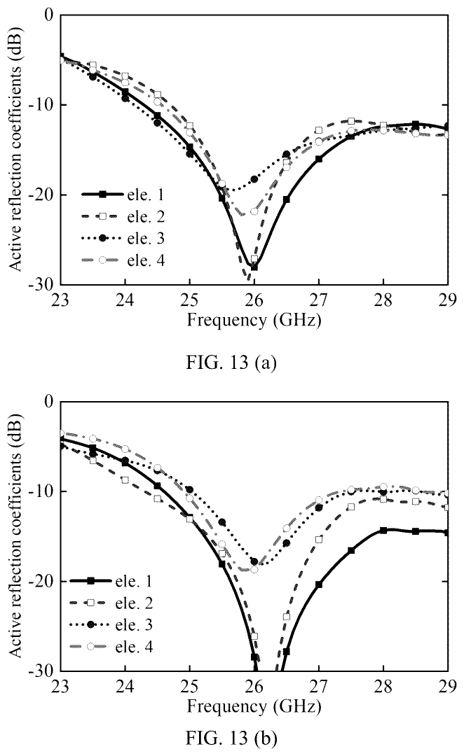

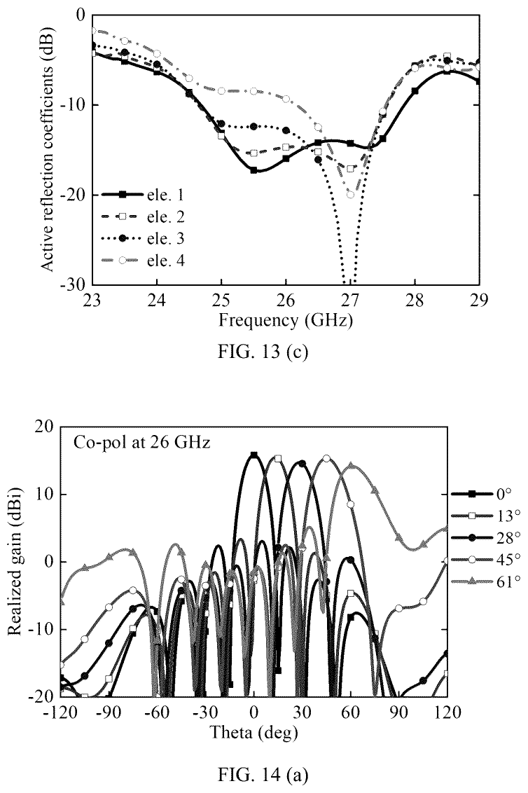

FIG. 12 shows the simulated reflection coefficients of elements 1-4 and the transmission coefficients between adjacent elements in the proposed DRA phased array. Here, since the array is completely symmetrical with the xoz plane (H-plane), only the relevant results of elements 1-4 are given for the sake of clarity. It can be observed that all these four elements are well matched, having an overlapping-10 dB impedance bandwidth of 14.6% ranging from 24.2 to 28.0 GHz. Moreover, thanks to the port self-decoupling technology, the isolations between any two adjacent elements are over 25.7 dB at 26 GHz. The DRA elements also achieve good active impedance matching at different scanning angles 0°, 28° and 61°, as shown in FIGS. 13 (a)-(c).

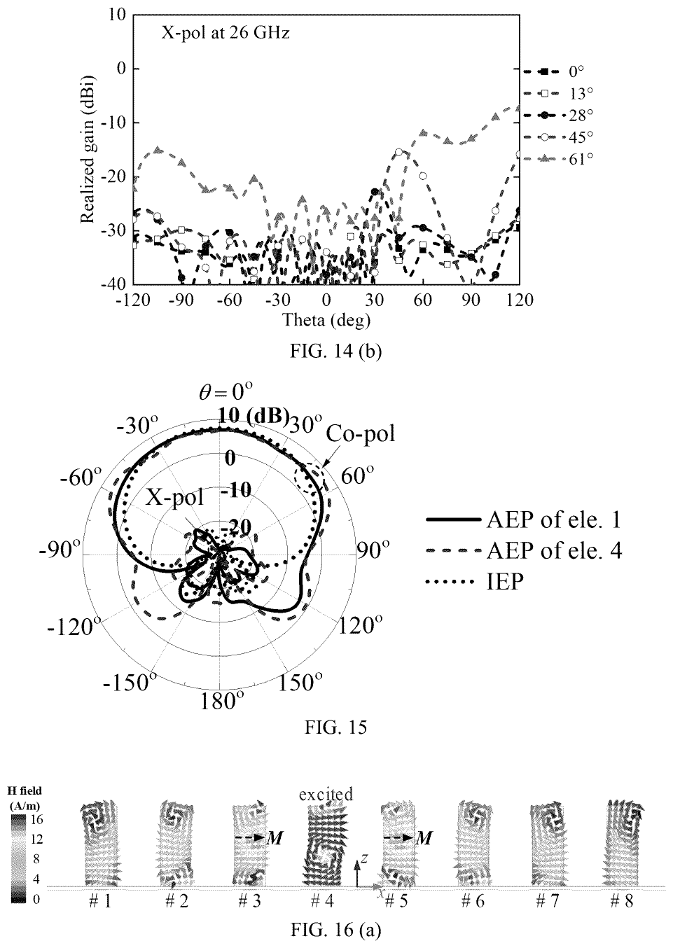

The scanning performance of the proposed DRA phased array at 26 GHz is illustrated in FIGS. 14 (a)-(b). As shown, the main beam can scan from −61° to +61°. Within the wide scanning range, the gain variation is only 1.6 dB, and the peak SLL is-9.1 dB. Again, due to the realization of WAIM by self-decoupling technology, the maximum beam gain at 0° is up to 15.8 dBi and the beam gain at large angle 61° is as high as 14.2 dBi. The detailed information about the beam-scanning performance at 26 GHz is summarized in Table 5, together with that at 25 and 27 GHz. Notably, other frequencies have also been studied, and they are not shown here just for brevity. The results show that the proposed DRA phased array achieves a wide ±60° beam-scanning bandwidth (within the whole band, the 3-dB beam-scanning range is over ±60°) of 12.7%, ranging from 24.2 to 27.5 GHz.

TABLE 5
Scanning performance of proposed millimeter-wave
H-plane DRA phased array at 25, 26, and 27 GHz

| | Scanning | Maximum | Gain | | Cross |
|---|---|---|---|---|---|
| Frequency | range | gain | fluctuation | Peak SLL | polarization |
| 25 GHz | ±63° | 15.1 dBi | 1.8 dB | −7.3 dB | <−25.0 dB |
| 26 GHz | ±61° | 15.8 dBi | 1.6 dB | −9.1 dB | |
| 27 GHz | ±60° | 16.7 dBi | 1.9 dB | −9.6 dB | |

Same as the proposed E-plane MPA phased array in Example 1, the wide-angle beam-scanning ability of the H-plane DRA phased array is also attributed to the widened AEPs, under the effect of near-field coupling. FIG. 15 shows the H-plane AEPs of elements 1 and 4 at 26 GHZ, along with the H-plane IEP. It can be observed that, both the AEPs of elements 1 and 4 have much wider beamwidth than the IEP. For a clear comparison, Table 6 lists the specific information about the HPBWs of the H-plane IEP and AEPs. It can be found that at 26 GHZ, the HPBWs of the AEPs of elements 1, 2, 3, and 4 are all over 30° wider than that of the IEP. Similar results are observed at 25 and 27 GHz. Notably, at 27 GHz, although the AEP of element 1 is only 95°, it is still 24° wider than that of the IEP. Moreover, the relative narrow AEP of edge element has no substantial impact on the beam-scanning performance of the DRA phased array, because other elements with widebeam AEP can make up for this defect.

TABLE 6
HPBW of H-plane IEP and AEP in 1-4 elements of proposed
H-plane DRA phased array at 25, 26, and 27 GHz

| Element | | IEP | 1 | 2 | 3 | 4 |
|---|---|---|---|---|---|---|
| HPBW/° | 25 GHz | 103 | 127 | 135 | 133 | 140 |
| | 26 GHz | 94 | 125 | 135 | 137 | 138 |
| | 27 GHz | 71 | 95 | 134 | 138 | 139 |

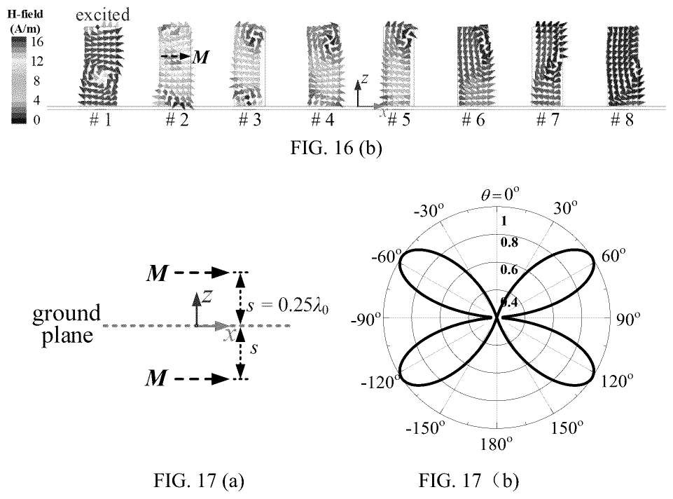

In the DRA phased array, it can be observed from FIG. 15 and Table 6 that the AEP beamwidth of the central element (element 4) is wider than that of the edge element (element 1). Similar to the MPA array, this is also caused by their different near-field coupling environments (locations). FIG. 16 (a)-(b) present the simulated magnetic-field distributions in the DRA array when only element 4 (FIG. 16(a)) or element 1 (FIG. 16(b)) is excited. As illustrated, the operating mode in excited element (element 4 or 1) is different from that in coupled element, which corresponds to TE₁₁₃(x) and TE₁₁₂(x) modes respectively. With reference to FIG. 16 (a), when only element 4 is excited, the energy is mainly coupled to adjacent elements 3 and 5, forming an equivalent magnetic current M in the +x direction, which is located at about 0.2510 above the ground plane. According to the image theory, the radiation pattern of passive element 3 or 5 can then be regarded as that generated by two magnetic currents of same direction located 0.25% above and below the ground plane. Consequently, its H-plane radiation pattern can be calculated by (8):

$${P}_{h} ( θ ) = ( {e}^{- jks cos θ} + {e}^{jks cos θ} ) \times \vert cos θ \vert . \qquad ( 8 )$$

FIGS. 17 (a) and (b) show the equivalent radiation model of coupled element 3/5 and its H-plane radiation pattern, respectively. It can be seen from FIG. 17 (b) that a radiation null appears in the boresight direction and the maximum radiation occurs at ±60° and ±120°. When this pattern superimposes with the IEP of excited element 4, the gains near ±60° and ±120° are reinforced while the gain in the boresight direction remains almost unchanged, thereby giving a more uniform AEP. This also explains why the AEP of element 4 has a relatively high gain near ±120° (see FIG. 15). When only element 1 is excited, as shown in FIG. 16 (b), similar magnetic current M in the +x direction is formed in passive element 2, thus the AEP of element 1 is also broadened. But differently, as there is no passive element on the left side of element 1, the broadening effect of AEP for element 1 is slightly inferior to that for element 4, leading to a relatively narrower HPBW. These results indicate that even if the coupled mode is different from the excited mode, a widebeam AEP can still be achieved by superimposing their complementary radiation patterns.

This disclosure proposes a novel design method for wide-angle beam-scanning phased arrays, in which the near-field coupling effect between antenna elements is skillfully utilized to realize widebeam AEP, while the port coupling effect is diminished by self-decoupling technique to obtain WAIM. On the basis of this method, an E-plane MPA phased array and an H-plane DRA phased array have been designed. It has been shown that without requiring any parasitic structure and active control circuit, both phased arrays achieve good beam-scanning performance. The MPA phased array can scan from −64° to +64° with a low gain fluctuation of 1.0 dB, while the DRA phased array can scan from −60° to +60° with a gain fluctuation below 3 dB within a wide frequency band of 12.7%. Also, high beam gains of 14.5 dBi and 15.8 dBi and low SLLs of −8.3 dB and −9.1 dB are obtained respectively in the MPA and DRA phased arrays. In addition to the great advantage of having simple configuration, this novel design method also has good universality. By using it, not only one-dimensional wide-angle scanning arrays can be realized, but also two-dimensional wide-angle scanning arrays and broadband wide-angle scanning arrays are potentially achievable. Finally, it should be emphasized that the field coupling and port coupling between antenna elements are analyzed and processed separately in our design, which utilizes the former while suppresses the latter. This opens a new window for future research on self-decoupling technique and wide-angle scanning phased arrays.

The above embodiments are the preferred embodiments of this disclosure, and the embodiments of this disclosure are not limited by the above embodiments. Any other changes, modifications, substitutions, combinations, or simplifications that do not deviate from the spirit and principles of this disclosure should be equivalent substitution methods and are included in the scope of protection of this disclosure.

1. A design method for a wide-angle beam-scanning phased array based on near-field coupling and port self-decoupling, wherein the wide-angle beam-scanning phased array comprises multiple antenna elements with identical structures, wherein element spacings between adjacent antennas are equal; wherein the design method comprises:
obtaining active element patterns of all antenna elements by exciting only a target antenna element, and terminating remaining antenna elements with matched loads, wherein the target element is an excited element and the remaining elements are coupled elements;
when an operating mode of a coupled antenna is a same as a resonant mode of the excited element, adjusting the element spacings between antennas to change a coupled field of the coupled element, which coupled field comprises a coupling amplitude and a phase, so as to broaden the active element pattern of the excited element based on a near-field coupling effect between the coupled element and the excited element, and thus enhancing the scanning angle of the said phased array;
when an operating mode of a coupled antenna is different from a resonant mode of the excited element, adjusting a radiation pattern of the operating mode of the coupled element, so as to broaden the active element pattern of the excited element based on a near-field coupling effect between the coupled element and the excited element, and thus enhancing the scanning angle of the said phased array.

2. The design method according to claim 1, wherein when an operating mode of a coupled antenna is a same as a resonant mode of the excited element, adjusting the element spacings between antennas to change a coupled field of the coupled element, comprising:
adjusting the element spacings between the antennas, so as to enable the phases of the coupled fields on both sides of the excited element to be consistent, enable phase differences between said coupled fields and the excited element to be within a range of 120° to 240°, and enable the amplitude of said coupled fields to be not all zero.

3. The design method according to claim 2, wherein the phased array consisted of identical MPA elements is printed on a top surface of a printed circuit board and excited by multiple coaxial probes via inset microstrip lines, without requiring additional beam-broadening and decoupling structures.

4. The design method according to claim 1, wherein, when the operating mode of the coupled antenna is different from the resonant mode of the excited element, the operating modes of the coupled elements have radiation patterns that are complementary to the resonant mode of the excited element.

5. The design method according to claim 4, wherein, the antenna elements are DRAs, the excited element operates at TE₁₁₃ mode; coupled elements symmetrically distributed on both sides of the excited element feature TE₁₁₂ mode.

6. The design method according to claim 5, wherein, each DRA is fed by a microstrip-coupled rectangular slot, wherein the slot is etched on a upper surface of a printed circuit board and excited by a stepped microstrip line, wherein the microstrip line is printed at a lower surface of a printed circuit board; the phased array does not require additional beam-broadening and decoupling structures.
